(19) United States
(12) Patent Application Publication
(10) Pub. No.: US 2021/0276579 A1
(43) Pub. Date: Sep. 9, 2021

(54) METHOD FOR CALIBRATING AND/OR ADJUSTING AT LEAST ONE SENSOR UNIT OF A VEHICLE

(71) Applicants: DAIMLER AG, STUTTGART (DE); ROBERT BOSCH GMBH, STUTTGART (DE)

(72) Inventors: HOLGER MIELENZ, OSTFILDERN (DE); EBERHARD KAUS, BOEBLINGEN (DE)

(73) Assignees: DAIMLER AG, STUTTGART (DE); ROBERT BOSCH GMBH, STUTTGART (DE)

(21) Appl. No.: 17/260,636

(22) PCT Filed: Jul. 11, 2019
(86) PCT No.: PCT/EP2019/068671

§ 371 Date: Jan. 15, 2021

(30) Foreign Application Priority Data
Jul. 17, 2018 (DE) 10 2018 117 290.7

(51) Int. Cl. B60W 50/06; B60W 60/00

(52) U.S. Cl. CPC B60W 50/06; B60W 2420/42; B60W 2420/52; B60W 60/001

(57) ABSTRACT

A method for calibrating and/or adjusting at least one sensor unit of a vehicle operated at least partially automatically may have in the event of a known need for calibration and/or adjustment of the at least one sensor unit along an upcoming roadway, at least one suitable road section for performing the calibration and/or adjustment is defined, on which the at least one sensor unit to be calibrated and/or adjusted is not necessary or is at least only minimally necessary or is needed as little as possible for the at least partially automated operation of the vehicle, where the calibration and/or adjustment of the at least one sensor unit occurs as soon as the vehicle reaches the defined road section.

The invention concerns a method for calibrating and/or adjusting at least one sensor unit of a vehicle, in particular a vehicle operated at least partially automatically.

From the prior art, as disclosed in DE 10 2014 016 342 A1, a method for calibrating a squint angle for single-image cameras of a stereo camera is known. Using at least one scanning unit separate from the vehicle's stereo camera, at least one distance from the vehicle to an object separate from the vehicle is detected. The squint angle is calibrated based on the detected distance.

DE 10 2010 021 221 A1 describes a method for determining an adjustment to a camera mounted on a vehicle with a suitable camera coordinate system relative to the vehicle with a suitable vehicle coordinate system. A current steering angle of the vehicle is detected. A series of images is taken by the camera, and corresponding image points are determined in time-sequential images. A steering angle range between a positive maximum possible and a negative maximum possible steering angle is defined in multiple partial angle ranges. In an overall image coordinate system for the images taken, motion vectors between corresponding image points are defined based on the current steering angle for each partial angle range, wherein one vanishing point in the image coordinate system is defined from at least two of the motion vectors for each partial angle range. At least two of the vanishing points are projected in the camera coordinate system and result respectively in a projected vanishing point. The vehicle coordinate system is reconstructed from the projected vanishing points in the camera coordinate system. The camera adjustment is defined from one rotation of the camera coordinate system relative to the vehicle coordinate system.

The invention is intended to provide a method that improves upon the prior art, for calibrating and/or adjusting at least one sensor unit of a vehicle, in particular a vehicle operated at least partially automatically.

The invention's objective is achieved by a method for calibrating and/or adjusting at least one sensor unit of a vehicle, in particular a vehicle operated at least partially automatically, according to the features in claim 1.

Advantageous embodiments of the invention are the object of the subordinate claims.

In a method according to the invention for calibrating and/or adjusting at least one sensor unit of a vehicle, in particular a vehicle operated at least partially automatically, especially during partially automated or highly automated operation of the vehicle on the road, in particular during autonomous and/or driverless operation of the vehicle on the road, in the event of a known need for calibration and/or adjustment of the at least one sensor unit along an upcoming roadway, at least one suitable road section for performing the calibration and/or adjustment is defined, on which the at least one sensor unit to be calibrated and/or adjusted is not necessary or is at least only minimally necessary or is needed as little as possible, and in particular is needed less on this road section than on all sections of the roadway, in particular for the at least partially automated or highly automated operation of the vehicle, specifically operation on the road, in particular for the autonomous and/or driverless operation of the vehicle, specifically operation on the road, in particular for managing a driving situation occurring on the respective road section. Calibration and/or adjustment, i.e., calibration or adjustment or calibration and specifically subsequent adjustment of the at least one sensor unit then occurs as soon as the vehicle reaches the defined road section. Calibration and/or adjustment, i.e., calibration or adjustment or calibration and specifically subsequent adjustment of the at least one sensor unit occurs in particular at least in partially automated or highly automated operation of the vehicle, specifically operation on the road, in particular in autonomous and/or driverless operation of the vehicle, specifically operation on the road.

The vehicle is specifically a street vehicle, in particular a motor vehicle.

The roadway is specifically a public thoroughfare, in particular a public roadway. It comprises, in particular a public street or multiple public streets, especially exclusively one or more public streets. In particular, all road sections of the roadway are public streets or are part of public streets.

The method is executed in particular automatically, in particular by the vehicle, in particular by a system for executing the method, wherein this system is specifically a component of the vehicle. The need for calibration and/or adjustment of at least one sensor unit is recognized in particular automatically, in particular by the vehicle, in particular by the system for executing the method. The at least one road section suitable for performance of the calibration and/or adjustment is defined on the upcoming roadway in particular automatically, in particular by the vehicle, in particular by the system for executing the method. Calibration and/or adjustment, i.e., calibration or adjustment or calibration and specifically subsequent adjustment of the at least one sensor unit is performed in particular automatically, in particular by the vehicle, in particular by the system for executing the method, as soon as the vehicle reaches the defined road section.

The method according to the invention allows increased system availability of one or more systems using the at least one sensor unit, in particular a system for executing the partially automated or highly automated operation of the vehicle on the road, in particular the autonomous and/or driverless operation of the vehicle on the road, and thereby achieves increased system availability and validity of such a system for executing the partially automated or highly automated operation on the road, in particular the autonomous and/or driverless operation on the road, of a vehicle equipped with it, because even while performing the calibration and/or adjustment, advantageously there must be no degradation of the automation level or such degradation can be limited as much as possible.

At least one sensor unit, such as an optical sensor unit, in particular a LiDAR sensor unit and/or camera unit, and/or a radar sensor unit, is or are calibrated and/or adjusted. Such sensor units are used in particular for executing the partially automated or highly automated operation on the road, in particular autonomous and/or driverless operation on the road, and can or must also be calibrated and/or adjusted, due to varying temperature conditions, for example, while the vehicle is operating on the road.

If multiple road sections are defined, any of which are suitable for performing the calibration and/or adjustment of at least one sensor unit, the best-suited road section is defined, for example, and the at least one sensor unit is calibrated and/or adjusted as soon as the vehicle reaches this best-suited road section. Calibration and/or adjustment is thus performed when it is causing the least impairment, for example, to partially automated or highly automated operation on the road, in particular autonomous and/or driverless operation on the road.

The road section is defined as best-suited, for example, on which the at least one sensor unit to be calibrated and/or adjusted is needed the least or in particular is not needed, in particular for the at least partially automated or highly automated operation of the vehicle, specifically operation on the road, in particular for the autonomous and/or driverless operation of the vehicle, specifically operation on the road, and/or which can be traversed during the calibration and/or adjustment of the at least one sensor unit without degradation of the automation level of the vehicle's operation on the road or with the least degradation of the automation level of the vehicle's operation on the road compared to other road sections, and/or on which the resulting reduction of the at least one sensor unit's performance during the calibration and/or adjustment is as limited as possible. This road section, which can be traversed without degradation of the automation level of the vehicle's operation on the road or with the least degradation of the automation level of the vehicle's operation on the road compared to other road sections, is most likely identical to the road section on which the at least one sensor unit to be calibrated and/or adjusted is needed the least or in particular is not needed, in particular for the at least partially automated or highly automated operation of the vehicle, specifically operation on the road, in particular for the autonomous and/or driverless operation of the vehicle, specifically operation on the road, and/or on which the resulting reduction of the at least one sensor unit's performance during the calibration and/or adjustment is as limited as possible, because degradation of the automation level would occur at the time when the at least one sensor unit is needed, in particular needed for the at least partially automated or highly automated operation of the vehicle, specifically operation on the road, in particular needed for the autonomous and/or driverless operation of the vehicle, specifically operation on the road, and is nonetheless calibrated and/or adjusted and when because of the calibration and/or adjustment, i.e., during it, a significant reduction in the sensor unit's performance occurs. In other words, when the sensor unit to be calibrated and/or adjusted is needed the least or in particular is not needed, in particular for the at least partially automated or highly automated operation of the vehicle, specifically operation on the road, in particular for the autonomous and/or driverless operation of the vehicle, specifically operation on the road, and/or when its performance reduction during the calibration and/or adjustment is as minimal as possible, it can be calibrated and/or adjusted without that causing degradation of the automation level of the vehicle's operation on the road.

Alternatively or additionally, the road section that the vehicle will reach first is defined as best-suited, if the calibration and/or adjustment needs to be done as soon as possible, for example. If, based on the abovementioned criteria for defining the best-suited road section, multiple, equally well-suited road sections are defined that could be considered as best-suited, for example, the one of these road sections defined as best-suited is that which the vehicle reaches first, so that the calibration and/or adjustment can be performed as soon as possible.

The upcoming roadway along which the at least one road section suitable for performance of the calibration and/or adjustment is defined, can be, for example, a driving route leading to a predetermined driving destination. Alternatively, it and in particular its length can be specified based on having a predetermined maximum length and/or a predetermined time requirement for driving over it. It can therefore be, for example, only a portion of the driving distance to the predetermined driving destination, in particular if the at least one sensor unit must be calibrated and/or adjusted within a specified amount of time and/or within a specified distance. This ensures that said amount of time and/or distance is/are respected. The driving time requirement therefore corresponds, for example, to the amount of time and/or the maximum length corresponds to the distance within which the calibration and/or adjustment of the at least one sensor unit must occur.

In one possible embodiment of the method, a section of the driving route to a predetermined driving destination is specified, in particular automatically specified, so that from among multiple possible roadways, the one chosen is that on which the at least one sensor unit can most quickly be calibrated and/or adjusted and/or on which the at least one sensor unit to be calibrated and/or adjusted is not needed or is at least needed less or is needed the least, in particular for the at least partially automated or highly automated operation of the vehicle, specifically operation on the road, in particular for the autonomous and/or driverless operation of the vehicle, specifically operation on the road. It is therefore possible that, if necessary, the driving route may be altered in order to allow for calibration and/or adjustment or to allow it to be done as quickly as possible, and/or to avoid driving maneuvers that can no longer be executed with high precision and/or safety by the sensor unit that is out of calibration and/or out of adjustment.

In one possible embodiment of the method, a new driving destination is specified, in particular automatically specified, for which there is at least one upcoming roadway with at least one road section suitable for performing the calibration and/or adjustment. The driving destination can therefore be altered in order to allow for the calibration and/or adjustment. Thereafter, for example, the originally specified driving destination can be used again to continue the trip.

Alternatively or additionally, a new driving destination can be specified, in particular automatically specified, to which the vehicle with at least one sensor unit that is out of calibration and/or out of adjustment can drive, in particular can drive without degradation of its operation automation level. In other words, for example, depending upon how significantly the at least one sensor unit is out of calibration and/or out of adjustment, a new driving destination is selected such that only safe travel of the vehicle is possible, in a parking lot, for example, and for which only driving maneuvers that can still be executed with the highest safety and precision are used.

In one possible embodiment of the method, for multiple sensor units to be calibrated and/or adjusted, the sensor units to be calibrated and/or adjusted are calibrated and/or adjusted one after another in different road sections. In this case, a sequence for calibrating and/or adjusting the sensor units is defined, for example, according to the degree of importance of each sensor unit, in particular for the respective road section, and in particular according to the degree of importance for performing the partially automated or highly automated operation of the vehicle on the road, in particular the autonomous and/or driverless operation of the vehicle on the road. This ensures that only one sensor unit is calibrated and/or adjusted in each road section while the other sensor units remain available, and that each sensor unit is calibrated and/or adjusted in a road section where the other sensor units are more important.

Examples of the invention are explained in more detail below, with reference to a FIGURE.

The FIGURE shows:

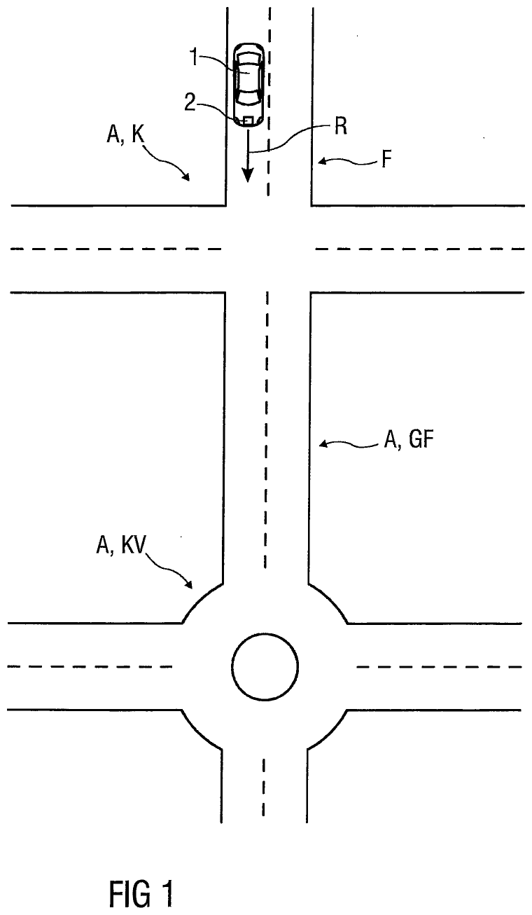

FIG. 1 schematic drawing of a vehicle on a roadway.

Based on a very simple situation, shown schematically in FIG. 1 as an example only, of a vehicle 1 on a roadway F, a method will be described below for calibrating and/or adjusting at least one sensor unit 2 or multiple such sensor units 2 of the vehicle 1, in particular during at least partially automated or highly automated operation, and in particular during autonomous and/or driverless operation of the vehicle 1 on the road. The vehicle 1 is specifically a street vehicle, in particular a motor vehicle. The roadway F is in particular a public thoroughfare, especially a public roadway F. It comprises in particular a public street or multiple public streets, especially exclusively one or more public streets. In particular, all road sections of the roadway are public streets or are part of public streets. The roadway F comprises multiple road sections A, which have different driving situations in the example shown. In the example shown, ahead of the vehicle 1 on the roadway F in driving direction R, first there is a road section A with an intersection K, then a road section A with a straight lane GF, and then a road section A with a roundabout KV.

Calibration of sensor units 2 on vehicles 1, in particular sensors for surroundings, specifically while the vehicle 1 is operating on the road, is basically already known from the prior art. It is also known as online calibration. In the event of such calibration and/or adjustment, an additional reduction in performance, i.e., operability, of the respective sensor unit 2 is to be expected during the calibration and/or adjustment, for example because switching an algorithmic method to perform calibration for a known period of time requires the full processing power of an applicable control device. This reduction in performance can cause, for example, complete disappearance of sensor measurement values, decreased update rates, or higher measurement precisions.

For an automated driving vehicle 1, in particular with a high automation level, for example SAE Level >=3 (Highly Automated Driving—HAF, Fully Automated Driving—VAF), the result of this is that within a sensor system a possibly necessary redundancy sensor is no longer available and the automation level has to be degraded in anticipation of it, in the form of a decrease in speed or shutdown of that system, for example.

This disadvantage is prevented by the method described below. In particular during the at least partially automated or highly automated, and especially autonomous and/or driverless, operation of the vehicle 1 on the road, if it is recognized that calibration and/or adjustment is needed for the at least one sensor unit 2, one or more road sections A that are suitable for the calibration and/or adjustment are identified along the upcoming roadway F, on which the sensor unit 2 to be calibrated and/or adjusted is not needed, is less needed, or is needed as little as possible, and in particular is needed less on that road section A than on all other road sections of the roadway F. In the example shown here, this is the relatively uncomplicated middle road section A with the straight lane GF. When the vehicle 1 reaches such road section A thus defined, the calibration and/or adjustment is initiated and performed, in particular at least during partially automated or highly automated operation on the road, and in particular during autonomous and/or driverless operation on the road.

For example, when multiple road sections A are defined, any of which are suitable for performing the calibration and/or adjustment of at least one sensor unit 2, the best-suited road section A can be defined and the at least one sensor unit 2 calibrated and/or adjusted as soon as the vehicle 1 reaches this best-suited road section A. Here, for example, the road section A is defined as best-suited on which the at least one sensor unit 2 to be calibrated and/or adjusted is needed the least or in particular is not needed, and/or which can be traversed during the calibration and/or adjustment of the at least one sensor unit 2 without degradation of the automation level of the vehicle operation on the road, or with the least degradation of the automation level of the vehicle 1's operation on the road compared to other road sections A, and/or on which a reduction of the at least one sensor unit 2's performance because of the calibration and/or adjustment is as limited as possible, and/or which the vehicle 1 reaches first.

To prevent calibration and/or adjustment from occurring too late, the upcoming roadway F along which the at least one road section A suitable for performance of the calibration and/or adjustment is defined can be, for example, of a nature such that it has a predetermined maximum length and/or a predetermined driving time requirement to traverse it. The driving time requirement corresponds, for example, to an amount of time within which the calibration and/or adjustment must be performed, and/or the maximum length corresponds, for example, to a distance within which the calibration and/or adjustment must occur.

The abovementioned disadvantages are therefore prevented by using the method described here in the manner described, in particular in that the calibration and/or adjustment of the at least one sensor unit 2 by means of this method is controlled in such a way that in the best case there is no degradation of the automated driving situation, in particular the automation level. In particular, upcoming driving situations on the upcoming roadway F (such as staying in a lane, turning, changing lanes, traversing the intersection K and roundabout KV, parking) are classified such that their demands on the various respective sensor units 2 are known. If a sensor unit 2 now needs to be calibrated and/or adjusted soon, for example due to going out of calibration after a temperature spike in the housing of the sensor unit 2 or for another reason, then the previously described process is used to analyze at which point in time, and in particular on which road section A, this sensor unit 2 is not needed, is needed less or as little as possible, and at that point in time, and in particular on that road section A, the sensor unit 2 is calibrated and/or adjusted.

The method and a corresponding system for executing the method therefore make it possible that, for the vehicle 1, in particular while automated and driving, depending on the existing and upcoming driving situation, in particular along the upcoming roadway F, a possibly necessary calibration and/or adjustment of at least one sensor unit 2, which is configured in particular as an optical sensor unit 2, for example configured as a LiDAR sensor unit and/or camera unit, in particular video camera unit, and/or as a radar sensor unit, can be performed in such a way that the activation, i.e., initiation, of the calibration and/or adjustment of the sensor unit 2 or any sensor unit 2 occurs when its performance, i.e., its operability, is not needed or is needed only slightly for the demands of the respective driving situation. This has the particular advantage that the respective driving situation, as already stated, can be traversed in the best case without any degradation of the automation level, because the expected reduction in the operability of the sensor unit 2 or any sensor unit 2 during the calibration and/or adjustment then has no effect on the demands of the driving situation, because the sensor unit 2 is not needed or is needed only very slightly for the demands of that driving situation.

In order to apply the described method, the system for executing the method as the components described below in particular.

The system comprises in particular an algorithmic method and a related control unit, which analyze sensor measurement values from the sensor unit 2 and interpret an existing effect, if applicable, from being out of calibration and/or out of adjustment, and define the need for recalibration and/or adjustment of the sensor unit 2.

The system further has a reference source, in the form of a database, for example, that assigns the sensor units 2 of the vehicle 1 to the respective driving situations for which they are necessary. Alternatively or additionally, the relevance of the respectively necessary sensor units 2 in a driving situation can be defined algorithmically, for example, by an existing street layout and applicable traffic rules, such as speed limits and/or other traffic rules.

In the method and by the system executing the method, in particular a length of time is defined for the upcoming driving situations that the vehicle 1, in particular driving automatically, will encounter. In other words, the particular driving situations ahead of the vehicle 1 and the sequential road sections A along the upcoming roadway F are defined. These driving situations can be inferred, for example, as part of route planning, over a planned route to a predetermined driving destination, for example, that includes the upcoming roadway F, and using map information. Alternatively or additionally, to determine the driving situation in the immediate surroundings of the vehicle 1, sensor information from the vehicle 1 scanning the surroundings can be used, i.e., in particular sensor information from one or more sensor units 2 on the vehicle 1.

The system further comprises an algorithmic method which, based on the upcoming driving situation on the road section A of the upcoming roadway F, the sensor units 2 needed for it, and knowledge of the sensor units 2 to be calibrated and/or adjusted, determines and initiates a time period for the calibration and/or adjustment operations.

If only one sensor unit 2 needs to be calibrated and/or adjusted, the road section A that is specifically suited for it is defined, and the calibration and/or adjustment is performed when that road section A is reached. If multiple sensor units 2 need to be calibrated and/or adjusted, advantageously such a road section A is defined for each sensor unit 2. In this way, advantageously, multiple, and in particular all, sensor units 2 are calibrated and/or adjusted not on the same road section A, but instead, at least when possible, sequentially on different road sections A, i.e., advantageously only one sensor unit 2 on a given road section A, so that the other sensor units 2 are available while a particular sensor unit 2 is calibrated and/or adjusted. For example, a sequence for calibrating and/or adjusting the sensor units 2 is defined according to the degree of importance of each sensor unit 2, in particular for the respective road section A.

In one possible embodiment of the method, it not only considers whether a given sensor unit 2 is needed or not needed for the given driving situation on the upcoming road section A, but also uses the range of sensor characteristics, such as detection ranges, classification levels, sight fields, etc. to assess in depth the performance reduction that will occur for each driving section and therefore each road section A. This information is then used in assessing the suitability of the road section A for calibration and/or adjustment and therefore in selecting the road section A on which the calibration and/or adjustment should occur, and for multiple sensor units 2 to be calibrated and/or adjusted advantageously also in determining the sequence for calibrating and/or adjusting multiple sensor units 2.

In one possible embodiment of the method, depending upon the sensor unit(s) 2 to be calibrated and/or adjusted, a route to a known and in particular predetermined driving destination is selected that allows for the quickest possible calibration and/or adjustment, in particular in which the driving situations, and therefore the road sections A with such driving situations, that require the sensor unit 2 or multiple sensor units 2 that are out of calibration or out of adjustment are circumvented as much as possible, i.e., these road sections A are avoided. In this way, advantageously a driving route to the predetermined driving destination is determined such that, out of multiple possible roadways F, the one chosen is that on which at least one sensor unit 2 or multiple sensor units 2 can most rapidly be calibrated and/or adjusted. Alternatively or additionally, the route to the driving destination can be determined such that any driving maneuvers that can no longer be executed with high precision and/or safety, due to a possible sensor unit 2 or multiple sensor units 2 that are out of calibration or out of adjustment, are avoided. In this way, advantageously, the driving route to the predetermined driving destination is determined such that, out of multiple possible roadways F, the one chosen is that on which at least one sensor unit 2 is not needed or is less needed or needed as little as possible.

In one possible embodiment of the method, depending upon how significantly the sensor unit(s) 2 is/are out of calibration and/or out of adjustment, a new driving destination is selected such that only safe travel of the vehicle 1 is possible, in a parking lot, for example, and for which only driving maneuvers that can be executed with the highest safety and precision are used. In other words, a new driving destination is then specified, to which the vehicle 1 with at least one sensor unit 2 that is out of calibration and/or out of adjustment or with multiple sensor units 2 that are out of calibration and/or out of adjustment can still drive, and in particular can drive without degradation of its operation automation level.

In another possible embodiment of the method, a new driving destination can be specified, for which there is at least one upcoming roadway F with at least one road section A suitable for performing the calibration and/or adjustment. In other words, in this case, advantageously but only temporarily, in particular only until the calibration and/or adjustment is completed, a new driving destination is determined that deviates, for example, from the driving destination in use until that point. After completion of the calibration and/or adjustment, for example, the originally determined driving destination can then be resumed and the drive to it continued.

The method is executed in particular automatically, in particular by the vehicle 1, in particular by the system for executing the method, wherein this system is specifically a component of the vehicle 1. The need for calibration and/or adjustment of at least one sensor unit 2 is recognized in particular automatically, in particular by the vehicle 1, in particular by the system for executing the method. The at least one road section A suitable for performance of the calibration and/or adjustment is defined on the upcoming roadway F in particular automatically, in particular by the vehicle 1, in particular by the system for executing the method. Calibration and/or adjustment, i.e., calibration or adjustment or calibration and specifically subsequent adjustment of the at least one sensor unit 2 is performed in particular automatically, in particular by the vehicle 1, in particular by the system for executing the method, as soon as the vehicle 1 reaches the defined road section A.

### LIST OF REFERENCE INDICATORS

1 Vehicle
2 Sensor unit
A Road section
GF Straight lane
F Roadway
K Intersection
KV Roundabout
R Driving direction

1-10. (canceled)

11. A method for calibrating and/or adjusting at least one sensor unit of a vehicle operated at least partially automatically, comprising:
in the event of a known need for calibration and/or adjustment of the at least one sensor unit along an upcoming roadway, at least one suitable road section for performing the calibration and/or adjustment is defined, on which the at least one sensor unit to be calibrated and/or adjusted is not necessary or is at least only minimally necessary or is needed as little as possible for the at least partially automated operation of the vehicle, wherein the calibration and/or adjustment of the at least one sensor unit occurs as soon as the vehicle reaches the defined road section.

12. The method of claim 11, wherein the calibration and/or adjustment of said at least one sensor unit is executed during partially automated or highly automated operation of the vehicle on the road during autonomous or driverless operation of the vehicle on the road.

13. The method of claim 11, wherein the at least one sensor unit is an optical sensor unit, a LiDAR sensor unit and/or camera unit, and/or a radar sensor unit, that is or are calibrated and/or adjusted.

14. The method of claim 11, wherein when multiple road sections are defined, any of which are suitable for performing the calibration and/or adjustment of at least one sensor unit, the best-suited road section is defined and the at least one sensor unit calibrated and/or adjusted as soon as the vehicle reaches this best-suited road section.

15. The method as in claim 14, wherein the road section is defined as best-suited on which the at least one sensor unit to be calibrated and/or adjusted is needed the least or is not needed for the at least partially automated operation of the vehicle, and/or which can be traversed during the calibration and/or adjustment of the at least one sensor unit without degradation of the automation level of the vehicle's operation on the road, or with the least degradation of the automation level of the vehicle's operation on the road compared to other road sections, and/or on which a reduction of the at least one sensor unit's performance because of the calibration and/or adjustment is as limited as possible, and/or which the vehicle reaches first.

16. The method of claim 11, wherein the upcoming roadway along which the at least one road section suitable for performance of the calibration and/or adjustment is defined, is determined in such a way that it falls within a predetermined maximum length and/or a predetermined driving time requirement to traverse it.

17. The method as in claim 16, wherein the driving time requirement corresponds to an amount of time within which the calibration and/or adjustment of the at least one sensor unit must be performed, and/or the maximum length corresponds to a distance within which the calibration and/or adjustment of the at least one sensor unit must occur.

18. The method of claim 11, wherein a section of the driving route to a predetermined driving destination is specified so that from among multiple possible roadways, the one chosen is that on which the at least one sensor unit can most quickly be calibrated and/or adjusted and/or on which the at least one sensor unit to be calibrated and/or adjusted is not needed or is at least needed less or is needed the least for the at least partially automated operation of the vehicle.

19. The method of claim 11, wherein a new driving destination is specified, which has at least one upcoming roadway with at least one road section suitable for performing the calibration and/or adjustment, and/or to which the vehicle with at least one sensor unit that is out of calibration and/or out of adjustment can drive, and can drive without degradation of its road operation automation level.

20. The method of claim 11, wherein for multiple sensor units to be calibrated or adjusted, the multiple sensor units to be calibrated or adjusted are calibrated or adjusted one after another on different road sections, wherein a sequence for calibrating and/or adjusting the sensor units is defined according to the degree of importance of each sensor unit for the respective road section.
